(19) United States
(12) Patent Application Publication
(10) Pub. No.: US 2015/0319933 A1
(43) Pub. Date: Nov. 12, 2015

(54) PLANT GROWTH SYSTEM USING LED LIGHTING

(71) Applicant: WAVIEN, INC., Valencia, CA (US)

(72) Inventor: Kenneth LI, Valencia, CA (US)

(21) Appl. No.: 14/704,395

(22) Filed: May 5, 2015

Related U.S. Application Data
(60) Provisional application No. 61/989,103, filed on May 6, 2014.
(60) Provisional application No. 62/027,979, filed on Jul. 23, 2014.
(60) Provisional application No. 62/140,026, filed on Mar. 30, 2015.

(51) Int. Cl. A01G 7/04; F21V 33/00; A01G 9/24; F21V 5/04; F21V 23/00; A01G 1/00; F21V 7/00; F21V 23/04

(52) U.S. Cl. CPC A01G 7/045; F21V 7/0091; F21V 33/00; F21V 23/0442; F21V 5/048; F21V 23/003; A01G 1/001; A01G 9/24; F21Y 2101/02

(57) ABSTRACT

A system for growing a plant includes an inwardly reflective enclosure and preferably a top. A plurality of LEDs, preferably controlled by a control unit, selectively emit light onto predetermined portions of the plant. The control unit controls the growing conditions inside the enclosure with the use of air vents and air flow, an optional heater, and feedback from light intensity and color sensors. The inwardly reflective enclosure can be formed of inner and outer walls with a reflective film sandwiched in between. If desired, a recycling collar can be used with any of the LEDs to increase the intensity of the light ray. The top cover can be formed of a plurality of panels rotatable about their longitudinal axis between a closed position and open position. In another embodiment, pair of inwardly reflective enclosures share a common, reflective wall with holes. The two enclosures are operated through light and dark cycles so as to exchange oxygen and carbon dioxide alternately with one another

### CROSS-REFERENCE TO RELATED APPLICATIONS

The present patent application claims priority on U.S. provisional application No. 61/989,103, filed on May 6, 2014; on U.S. provisional application No. 62/027,979, filed on Jul. 23, 2014; and on U.S. provisional application No. 62/140,026, filed on Mar. 30, 2015

### BACKGROUND

In recent years, the efficiency of LEDs has improved tremendously. With drastically lower prices, it has become feasible for LEDs to be used as lighting sources for plant growth. Because LEDs can illuminate a plant continuously at reasonable cost, and with a light intensity potentially greater than that of the sun, the rate of growth can be increased beyond natural growth under natural sunlight conditions. It is also possible now to grow plants in winter, when sunlight is minimum, and at night time when it is dark.

Besides lighting conditions, it is also common for plants to growth best at certain temperatures. Greenhouses are designed such that the temperature is controlled providing the most optimum conditions. It is also known that based on the color of the leaves, the absorption spectrum of the leaves differ based on the type to type of plants.

### SUMMARY OF THE INVENTION

This invention discloses a scalable self-contained LED plant growth lighting system integrated with the green house in which the LED are placed inside a housing with reflective inside surfaces. The temperature of the system can be controlled by air vents, which control the removal of heat generated by the LEDs, providing the optimum growth temperature. In addition, the color of the LEDs can be chosen to match the absorption spectrum of the chlorophyll in the leaves. With such enclosed system, CO₂ can be added with minimal loss, further increasing the growth rate of the plant. Such recycling light system also allows illumination of the bottom of the leaves by placing LEDs under the leaves, increasing the area of photosynthesis, further increases the growth rate of the plant.

More particularly, a system for growing plants includes an inwardly reflective enclosure and preferably a top. Pluralities of LEDs, preferably controlled by a control unit, selectively emit light onto predetermined portions of the plant. The control unit controls the growing conditions inside the enclosure with the use of air vents and air flow, an optional heater, and feedback from light intensity and color sensors.

The inwardly reflective enclosure can be formed of inner and outer walls with a reflective film sandwiched in between. If desired, a recycling collar can be used with any of the LEDs to increase the intensity of the light ray. The top cover can be formed of a plurality of panels rotatable about their longitudinal axis between a closed position and open position, to control both the admission of light and the flow of air. In another embodiment, pair of inwardly reflective enclosures share a common, reflective wall. The shared wall includes holes to allow oxygen to flow from one chamber to another and allow carbon dioxide to flow from the other chamber into the first chamber. The two enclosures are operated through light and dark cycles so as to exchange oxygen and carbon dioxide alternately with one another.

Alternatively, the system described above can be operated so that one chamber is a sacrificial chamber, which is provided with dead organic matter, for example lawn clippings, to emit carbon dioxide to the other chamber to speed growth.

The increase in efficiency also allows higher efficiency of electricity usage, which is a major cost of production. With the lack of energy resources and the need to lower the particulate pollution and CO₂ emission, the increase in efficiency in electricity use will be an important factor.

### BRIEF DESCRIPTION OF THE DRAWINGS

FIG. 1 is a side, schematic drawing of a plant growth system according to the invention;

FIG. 2 is side, schematic view of an alternative system;

FIG. 3 is a side, schematic view of another system according to the invention;

FIG. 4 is a side, schematic view of another system according to the invention;

FIG. 5 is a side, schematic view of another system according to the invention;

FIG. 6 is a side, schematic view of another system according to the invention;

FIG. 7 is a side, schematic view of another system according to the invention;

FIG. 8 is a side, schematic view of another system according to the invention;

FIG. 9 is a side, schematic view of another system according to the invention;

FIG. 10 is a side, schematic view of the rotatable reflective panels of the FIG. 9 embodiment in the closed and open positions;

FIG. 11 is a side, schematic view of another system according to the invention;

FIG. 12 is a side, schematic view of another system according to the invention;

FIG. 13 is a side, schematic view of another system according to the invention;

FIG. 14-20 are perspective views of various alternate shapes for housings used in the system according to the invention;

FIG. 21 is a side, schematic view of a known system for growing plants;

FIG. 22 is a perspective, schematic view of another system according to the invention, along with top views of various alternatively shaped housing enclosures;

FIG. 23 is a perspective, schematic view of the cylindrical housing enclosure of FIG. 22, together with various alternate shapes of the sidewall;

FIG. 26 are side, schematic views of other lighting arrangement for a system according to the invention;

FIGS. 27-29 are schematic, perspective views of other lighting sources for use with a system according to the invention;

FIG. 30 is a side, schematic view of another system according to the invention; and

FIG. 31 is a side, schematic view of another system according to the invention;

### DETAILED DESCRIPTION OF THE PREFERRED EMBODIMENTS

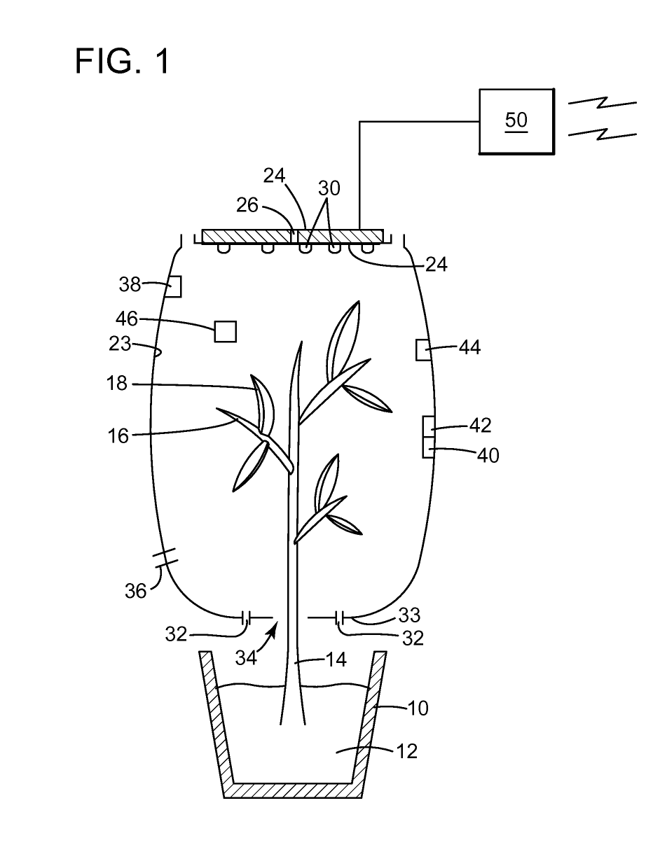

FIG. 1 is a schematic diagram of a basic system. In the following discussion of the first embodiment, the plant is represented by a pot 10, soil 12 in the pot, a stem 14, branches 16, and leaves 18, with the optional fruit left out for simplicity purposes. The recycling lighting system includes an enclosure 20 with reflective inside surfaces 23, and a preferably removable top cover 24 with air vents 26 passing therethrough. The enclosure includes sides and a bottom portion 33 having air vents 32 to allow air to enter and leave the interior of the enclosure 20. The upwardly facing surface of the bottom portion 33 also includes an inside reflective surface. Due to the vents 32 and 26, during certain temperature conditions, air can enter the bottom portion 33 through the air vents 32 in the bottom portion 33 and exit upwardly through the air vents 26 in the top cover 24 to control the temperature inside the enclosure 20.

One or more LEDs 30 of one or more colors are mounted on the underside of the top cover 24 so as to shine light on the leaves 18. Except for the air vents 26 and the LEDs, the remainder of the bottom surface of the top cover 24 is covered with a reflective material. The bottom portion 33 includes an opening 34 through which the stem extends. Although not specifically shown, the bottom portion 33 is configured to be removed and secured around the stem 14 when desired. For example, the bottom portion 33 may include two pieces and be removably secured to the enclosure. When removed, the two pieces pivot or separate relative to one another so that the bottom portion 33 can either be attached around, or removed from, the stem 14,

The enclosure 20 may include a CO₂ intake port 36, a temperature sensor 38, a heater 40, an insulation jacket (not shown), a CO₂ sensor 42, a light intensity sensor 44, and a color sensor 46 for the leaves. The enclosure 20 can also include a fan for circulating air within the enclosure and moving air in and out of the enclosure.

While the top cover 24, when closed, is shown in a fixed position, preferably it is secured to the enclosure 20 as to be movable up and down, allowing the enclosure to lengthen as the plant grows taller. The system also includes a power supply and a control unit 50 which can communicate, preferably wirelessly, with the sensors and heater and control lighting of the LEDs, including turning them on and off, adjusting the intensity, and selecting which color LEDs to illuminate based on the readings from the color sensor 46.

In FIG. 1, the LEDs 30 are placed below the top cover 24 of the enclosure with light directed downwardly towards the leaves 18. Part of the light will also be directed toward the reflective side surface 23 of the inside of the enclosure and will reflect back towards the leaves 18. With high reflective coatings on the surfaces, very little light will be lost and the light will eventually be absorbed by the leaves, in some cases after multiple bounces off of the inside reflective surfaces 23, 24. The efficiency of the system is also assured because the bottom portion 33 of the enclosure does not allow light from the LEDs 30 to illuminate the soil or pot, in which case light energy would be lost. This is especially significant during the initial cycle of growth when the number and size of the leaves 18 are minimal and, in a traditional growth method, a great deal of soil is exposed.

The enclosure also acts as a greenhouse, trapping the heat generated by the LEDs. Optionally, an insulating jacket (not shown) can be wrapped around the outside of the enclosure 20 to increase the temperature to the desired optimum value.

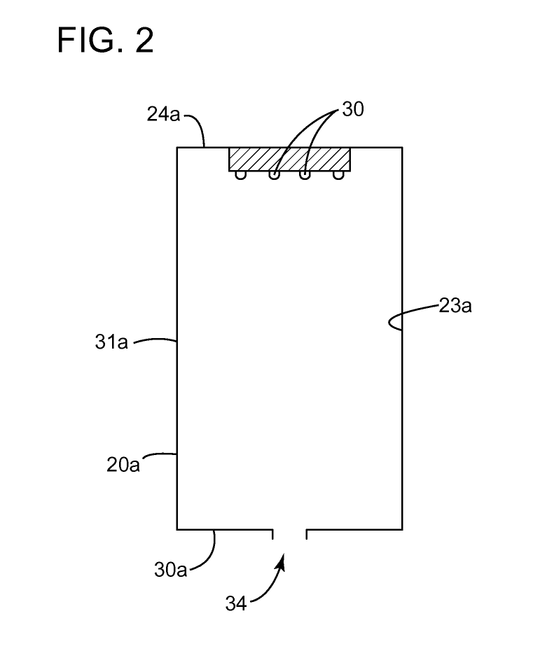

In FIG. 1, the enclosure is shaped essentially like a stemless wine glass. Alternately, the enclosure 20a can be cylindrical as shown in FIG. 2 with a circular upper lid 24a where the LEDs 30 are mounted, which also acts as a heat sink, and a lower cover 30a with an aperture 34 for the stem to pass through. As in the case of FIG. 1, the lid 24a is preferably removable, or at least can open, and also preferably can be positioned at various heights to allow the LEDs to be repositioned as the plant grows.

The inside walls of the enclosure are made reflective by putting on metal or dichroic coatings 23a made by vacuum deposition, open deposition, painting, or any other suitable method. The walls 23a can also be made reflective by putting a reflective sheet, such as reflective films made by 3M, on the inside surfaces. LEDs can also be placed on the lower cover 30a and the sidewall 31a, increasing the intensity of the light, thus increasing the growth rate.

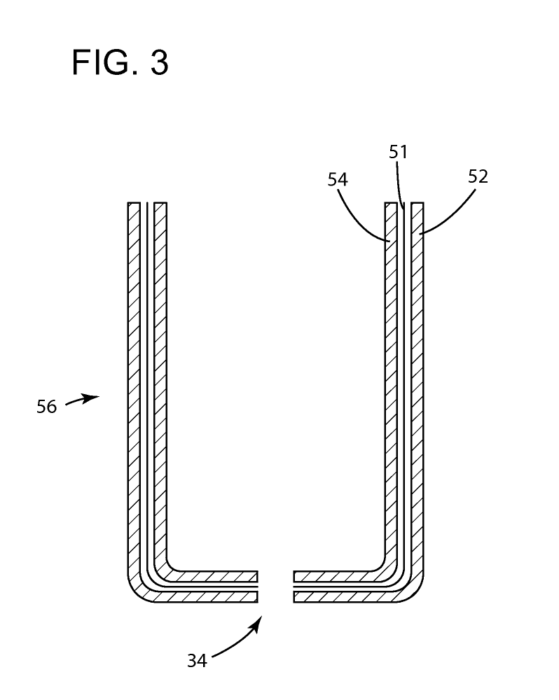

In another embodiment, the reflective films 51 can be placed inside the gap between two layers 52, 54 of a double wall as shown in FIG. 3. This provides better protection of the reflective surface. Although not shown, the enclosure 56 in FIG. 3 also includes a top cover 24b to form an enclosed space for the plant.

The enclosure can be made of glass, plastic, metal, etc. The enclosure can also be molded to reduce production costs. In one embodiment, the enclosure can be made in multiple pieces put together in a clam-shell type of construction which opens and closes to insert or remove the plant.

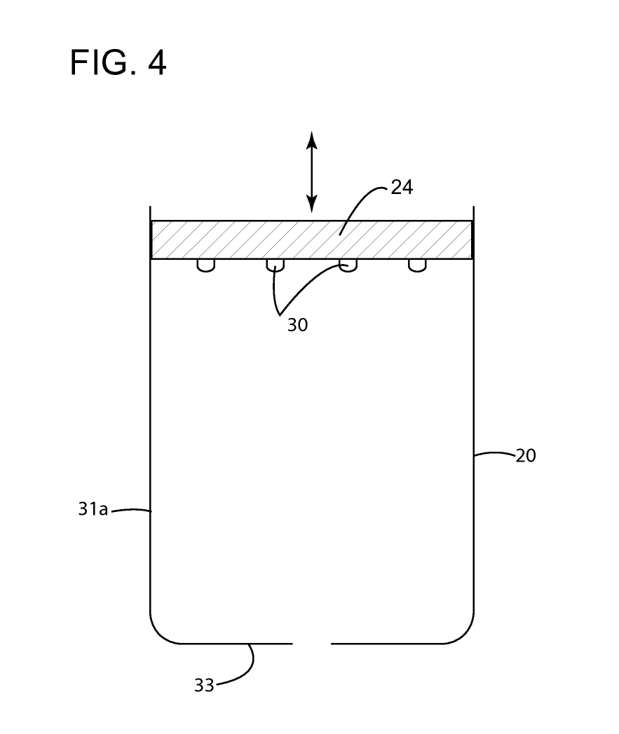

FIG. 4 shows the enclosure 20 with a top cover 24 which is mounted inside the sidewall in a manner in which it can be repositioned to move the LEDs 30 to an appropriate height to accommodate the plant as it grows. For example, the top cover 24 can have a friction fit with the inside surface of the enclosure sidewall 31a. Other mounting systems may also be employed. The top cover 24 can be coupled to a motor (not shown) which in turn is controlled by the control unit 50 of FIG. 1 to periodically reposition the top cover 24. Any suitable mounting configuration may be employed to allow the top cover 24 to move vertically.

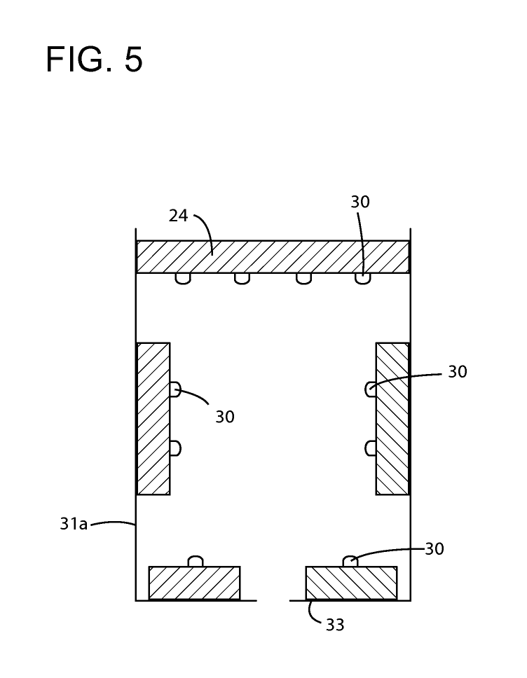

FIG. 5 shows another embodiment in which LED arrays 30 are placed, in addition to the top cover, on the sidewalls 31a and the bottom cover 33. This arrangement of LEDs allows the illumination of the leaves from many directions, increasing the growth rate of the plant.

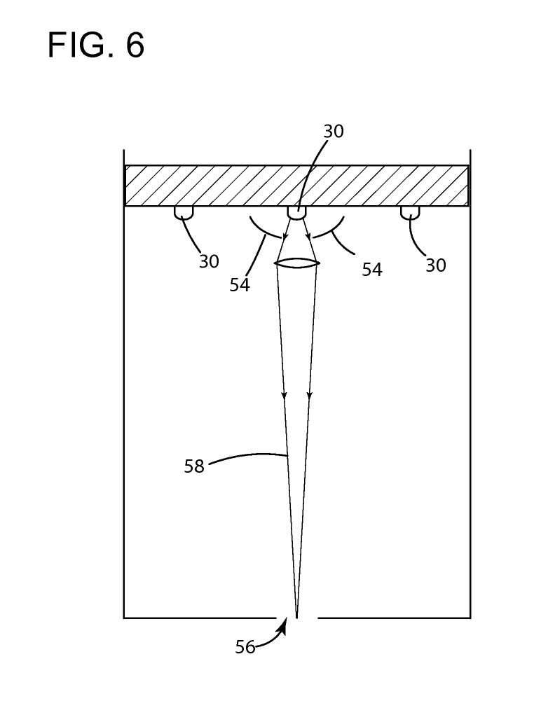

Referring to FIG. 6, during part or all of the growth cycle of a plant, for example, the initial growth period when there are only a few small leaves, a special LED lighting source can be added to the top cover using a recycling light technology developed by Wavien, Inc. Such technology involves the use of a recycling collar 54. The recycling collar 54 has a curved concave reflective surface which faces the LED 30, and a central aperture 56 which is positioned relative to the LED 30 in the path 58 of desired direction of the light beam. With the recycling collar 54, light emitted by the LED 30 in the direction of the light path 58 passes through the aperture 56 and is directed towards one or more of the leaves 18 of the plant. Larger angle light beams strike the interior reflective wall of the collar 54 and are reflected back towards the LED, either directly or indirectly, for recycling. If desired, light emitted from the collar 54 can be directed to pass through a lens 55. The collar increases the intensity of the light so as be several times higher than the LED emits on its own. The use of such technology further increases the initial growth rate.

Preferably, each collar 54 is removably secured to the top cover 24 to cover one LED 30. If desired, the collar 54 may be removably secured to the LED itself. In such a manner, during the young plant's life, initially all of the LED light is directed by the collar 54 towards the few initial leaves 18 to increase the growth rate. As the plant matures, the collars are removed so that the LED light is directed towards more of the newer leaves. Once the plant is removed, the collar 54 can be reattached to grow the next young plant.

The absorption spectrum of the leaves can also be determine by the colors it reflector. As there are many colors of the leaves, there will be as many optimum light spectra for optimum growth of various plants. Various quantities of LEDs with various colors can be combined to produce the desired optimum spectrum for any particular. Since each LED, or a group of LEDs, can be controlled independently by the control unit 50, the various colored LEDs can be connected to a controlled circuit, optionally controlled by computers. Since the color of the leaves change during growth, the color of the LEDs can also be adjusted for optimum growth rate. The control unit 50 thus monitors readings from the color sensor 46 and adjusts the color of the LEDs illuminated accordingly.

In all of the embodiments, a color sensor unit 46 can be used to detect the color of the leaves and adjust the color of the LED lights accordingly for optimum growth rate.

The previous descriptions are for a single lighting system placed together with a single plant. The system can be scaled up for high volume production with multiple units placed in an array on shelves in close proximity. In such arrangement, some of the components can be combined into single units lowering the cost of the system. For example, a single power supply can be used to drive multiple units of lighting systems. A single control unit can be used to control multiple lighting systems. Instead of a single plant growing in a single pot, multiple plants can be placed inside a single larger pot. In another embodiment, multiple plants can be grown on land without any pot.

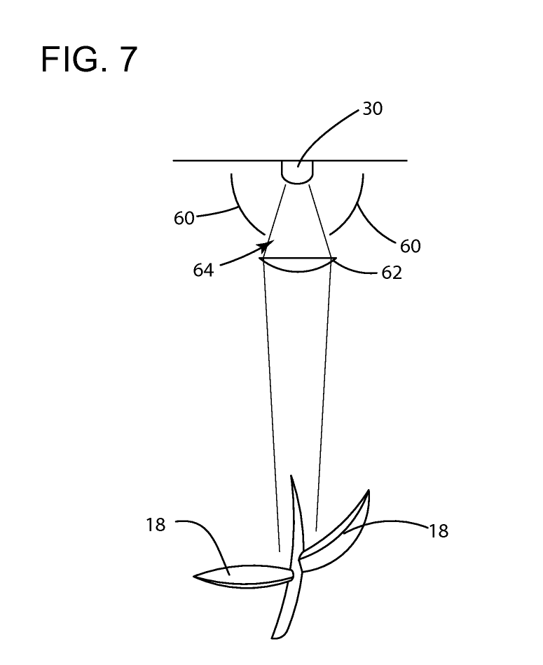

FIG. 7 shows an embodiment of a lighting system using a single recycling collar 60 and a collimating lens 62. The collar 60 has a convex reflecting surface, e.g., round, which faces the LED 30. The collar 60 also as a center opening 64 and the lens 62 is positioned to receive light which exits the recycling collar 60 through the opening. Due to the recycling collar 60, light rays which are emitted by the LED 30 at an angle greater than a predetermined angle strike the collar reflective surface and are reflected back to the LED for recycling. Lower angle rays exit the opening 64 and strike the collimating lens 62, which directs such rays toward the leaves 18. In effect, the collar 60 acts to concentrate the rays so that those striking the leaves 18 have increased brightness to increase the growth rate of the plant.

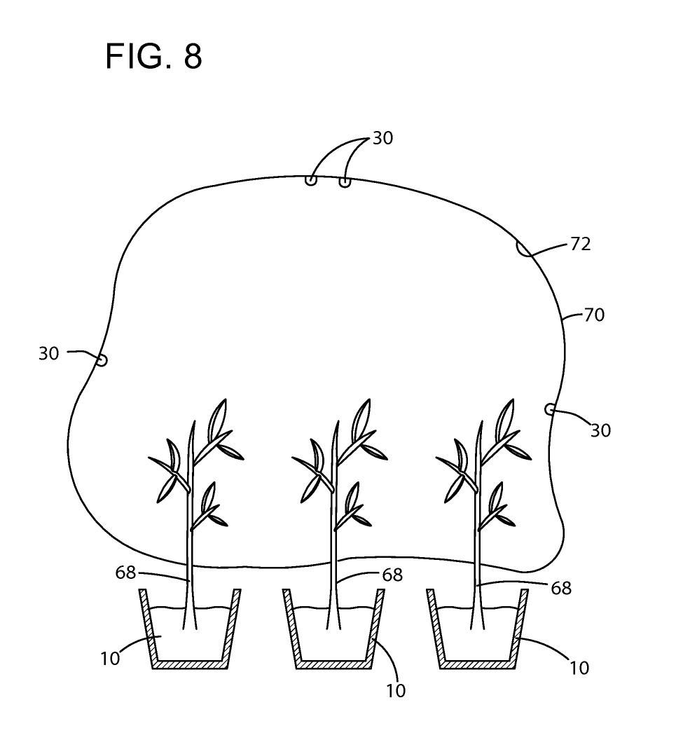

In the above embodiments, the soil and the pots are placed away from the lighting system, allowing ease in irrigation. In a similar manner, a large-scale implementation of such system can be done as shown in FIG. 8. Multiple plants 68 are spaced at certain distances apart, with their roots soil 12 which is either in pots 10 or in the ground (not shown). The ground surface in the spaces between the plants 68 are covered with reflective materials such that light will be reflected instead of wasted. Again, this is significant when the plants are small with few leaves at the initial stage of growth. A greenhouse 70 is constructed around the plants with all inside surfaces are covered with reflective materials 72. LED growth lights 30 are then placed inside the reflective material 72 above, below, and on the sides of the plants providing maximum illumination.

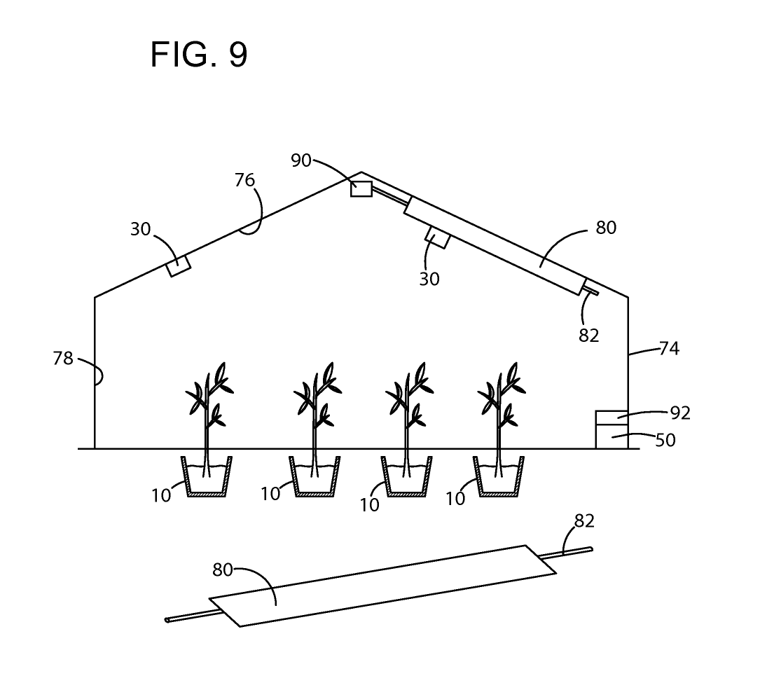

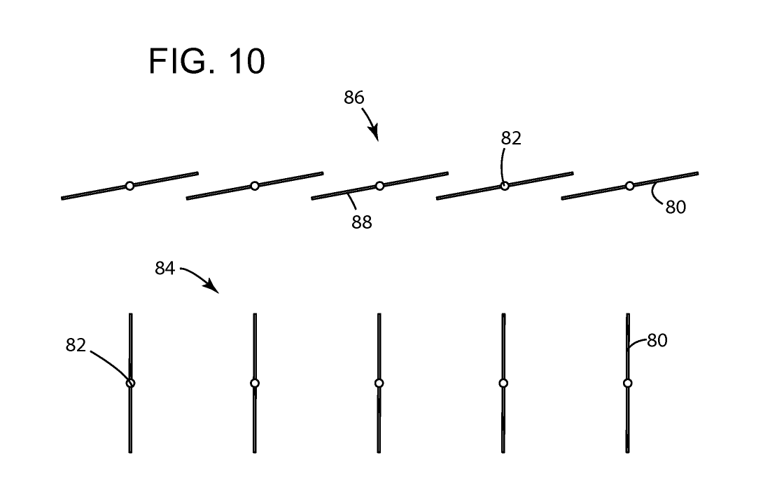

As shown in FIGS. 9 and 10, in another embodiment, the enclosure 74 has a ceiling 76 and side walls 78 covered with flat, elongated reflective panels 80. Each panel 80 is mounted on a pivot 82 so that it can be rotated between an open position 84 and a closed position 86. In the closed position, the longitudinal edges 88 of the panels 80 preferably overlap or abut one another closely to block, or at least substantially block, outside light from entering the interior of the enclosure 74.

In the embodiment of FIGS. 9 and 10, during the hours of sunshine, the reflective panels 80 are kept in the open position 84 such that the sunlight can penetrate through the spaces and illuminate the plants. When the sunlight is weak or absent, the reflective panels 80 are rotated into the closed position forming a completely enclosed greenhouse with reflective interior surfaces. The LEDs 30 are then illuminated as the light source. Such implementation allows effective use of sunlight and LED light with optimum growth rates, while saving electricity. The opening and closing of the panels 80, and turning the LEDs on and off, can be controlled by the control unit 50 using a motor 90 and a light sensor 92.

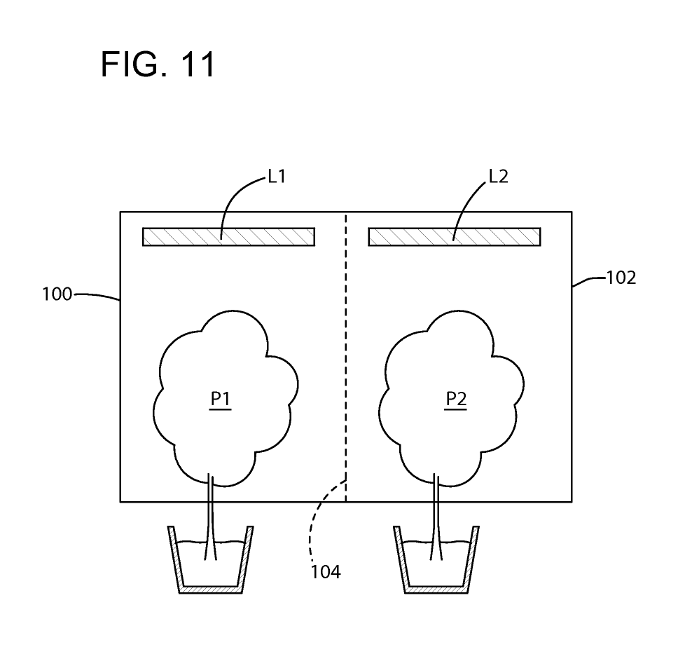

One of the known methods to increase the growth rate is to increase the concentration of carbon dioxide (CO₂) during photosynthesis. Farmers with greenhouses would often burn propane to increase the concentration, which is not energy efficient. FIG. 11 discloses a system and method of increasing the carbon dioxide concentration by using two chambers 100, 102, which are separated from one another by a reflective partition 104 having air passages therethrough. The outside surfaces of the chambers 100, 102 are also covered by a reflective wall, and an LED light source L1 and L2 is placed in each chamber 100, 102.

The explanation of the system is simplified by referring only to two plants, P1 and P2. Plant P1 is placed inside chamber 100, and plant P2 is placed in the other chamber 102. The area of the air passage through the partition 104 will be small compared to the area of the partition such that the light loss will be minimized. If necessary, reflective shades (not shown) can be used to prevent light leakages.

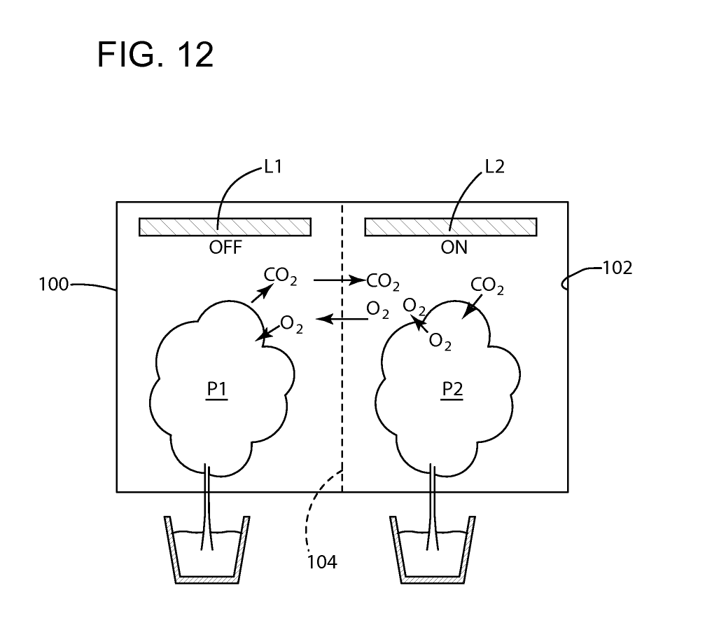

The light cycling has two phases. In the first phase, the plant P1 is resting in the dark with lamp L1 turned off as shown in FIG. 12. The plant P1 will not undergo photosynthesis and will be absorbing oxygen (O₂) and releasing carbon dioxide (CO₂). In the other chamber 102, light L2 is on and P1 will be absorbing carbon dioxide and releasing oxygen through photosynthesis. The net result is that the plant P1 supplies extra carbon dioxide to the plant P2, and the plant P2 supplies extra oxygen for P1.

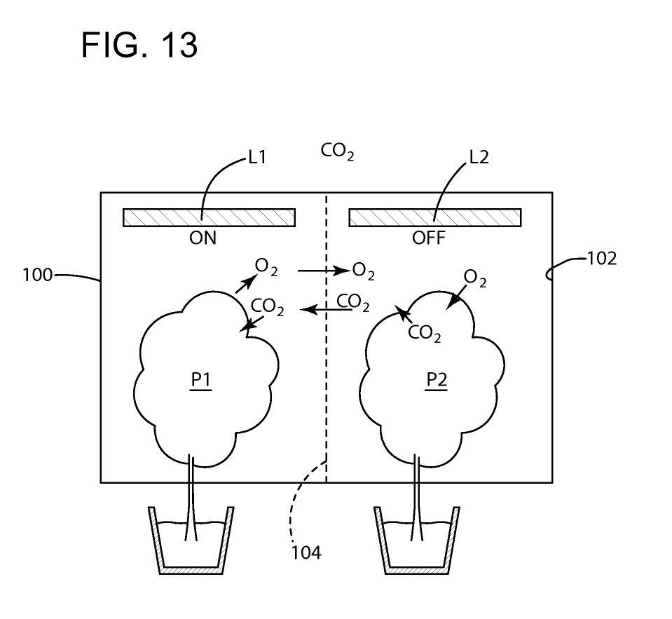

During the second phase, shown in FIG. 13, the system is reversed. The light L1 is on, and the light L2 is off Plant P1 supplies oxygen to plant P2, and plant P2 supplies carbon dioxide to plant P1. For certain plants, both L1 and L2 can be on or off at the same time depending on the optimization of the growth rates.

This system can be further extended to have sacrificial plants such that the light is always off. If plant P1 is a sacrificial plant, the light L1 will remain off, and plant P1 emits carbon dioxide to help plant P2 to growth faster. In this case, the light L1 will remain off at all times and plant P1 will eventually wither and die producing carbon dioxide during its life. Such sacrificial plant P1 can be a species different from plant P2, or can be fresh plant clippings such that they are still living. For example, cut grass from mowing the lawn can be used as sacrificial plants. The cut grass can be used in place of P1 and stay in the dark until it withers and dies, while provide carbon dioxide for plant P2 speeding up the growth. As in other embodiments, the parameters for operating the phases can be programmed into the control unit 50 to turn the lights on and off at the appropriate times.

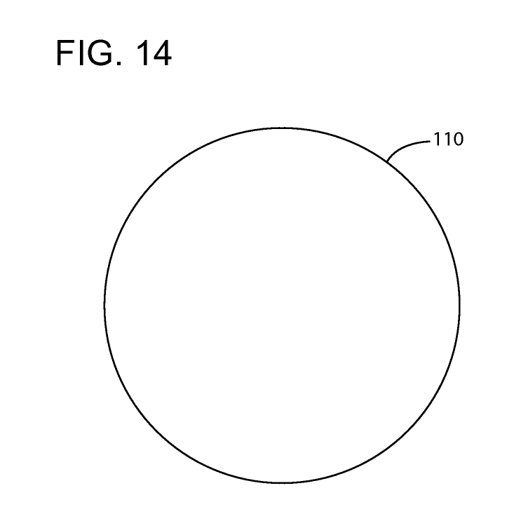

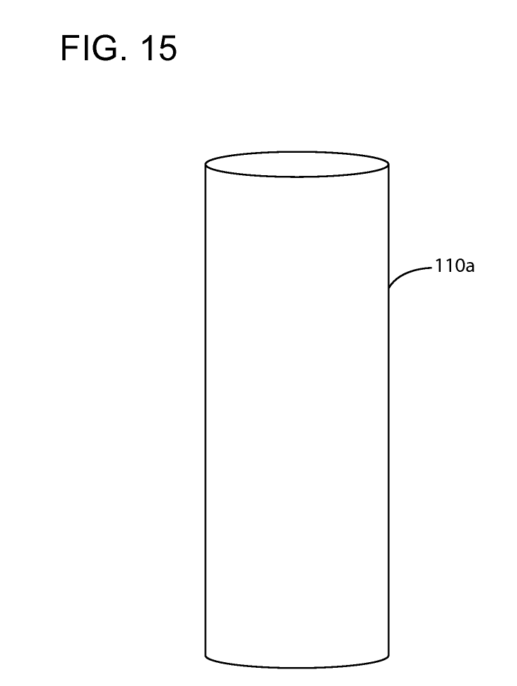

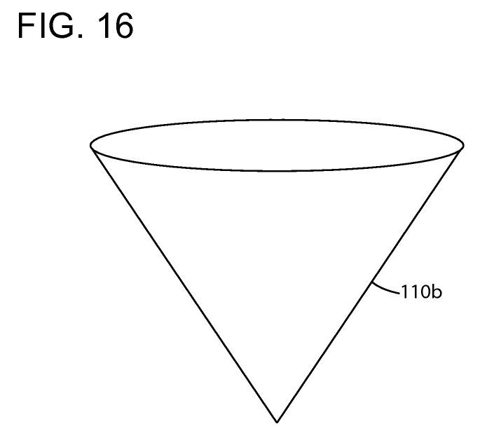

The light recycling enclosure 110 can be spherical as shown in FIG. 14. In this case, the light will be mixed inside the enclosure without a particular pattern. The enclosure 110a can also be cylindrical accommodating taller plants as shown in FIG. 15. FIG. 16 shows a conical enclosure 110b for plants with longer stems and with leaves on top.

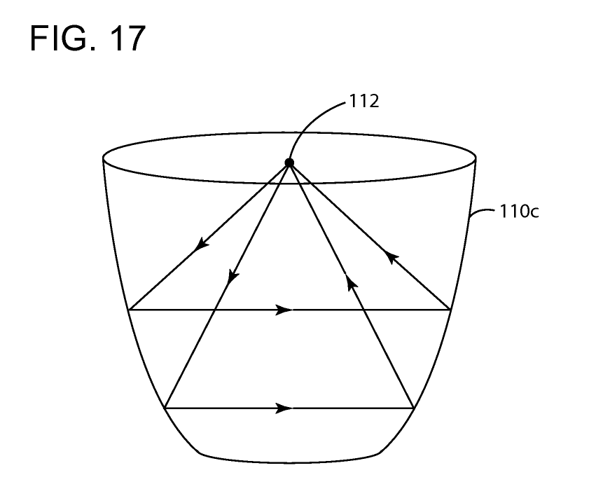

FIG. 17 shows a dual parabolic reflector enclosure 110c with a focus 112 with certain predetermined light paths as shown. The enclosure 110c can be used in any of the embodiments of the invention.

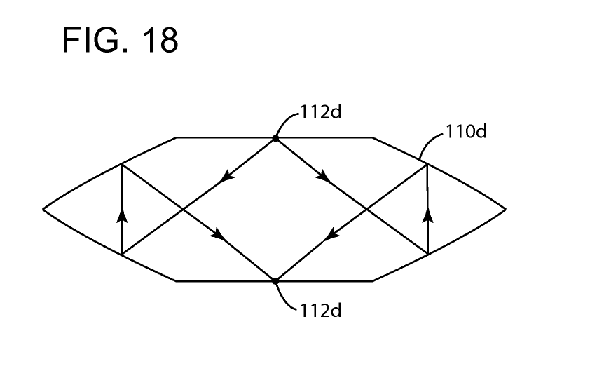

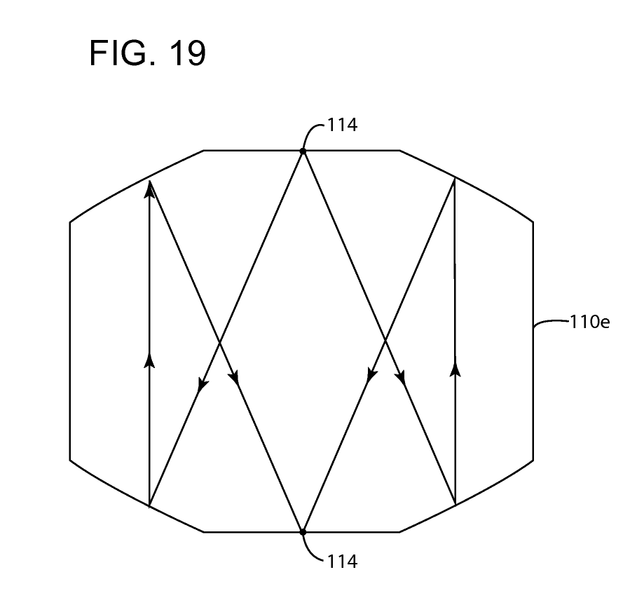

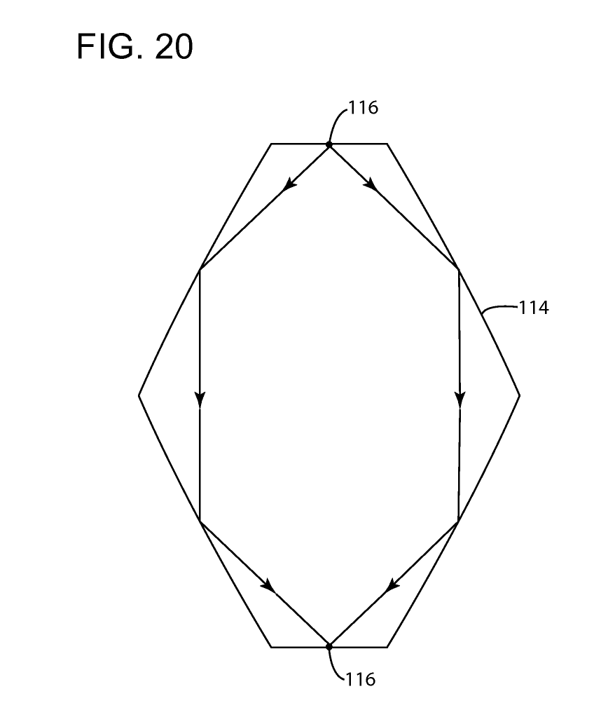

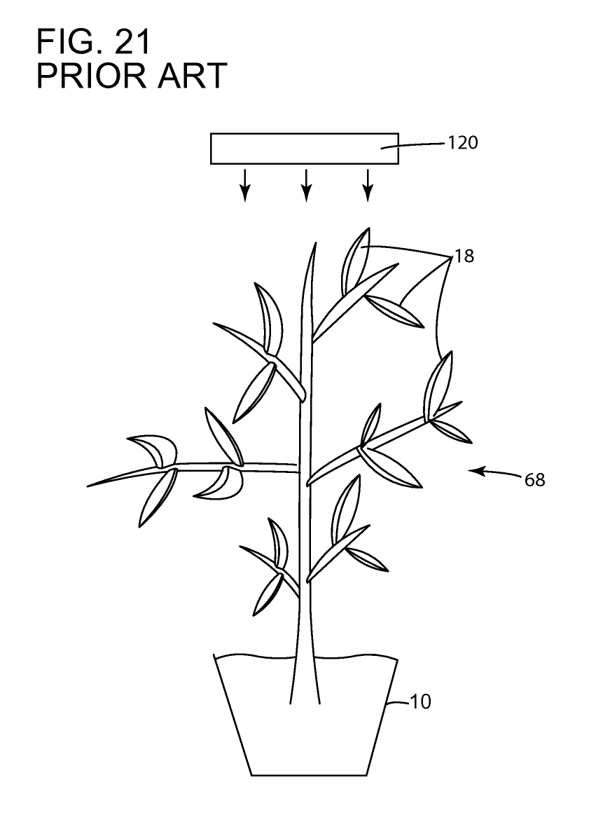

FIG. 18 shows another dual parabolic reflector enclosure 110d with more than one focus 112d with light paths as shown. FIG. 19 shows a truncated dual parabolic reflector enclosure 110e with two foci 114. FIG. 20 shows another dual parabolic reflector enclosure 110f with foci 116 These systems with special reflectors can be used where specific light patterns are desired for certain plants with certain leave/stem shapes, providing further optimization for increased growth rates.

FIG. 21 shows a typical plant growth system using a light source 120 at the top, with a plant 68 in a container or pot 10. This system is simple, but not very efficient in the use of light and available leaf surfaces for photo-synthesis.

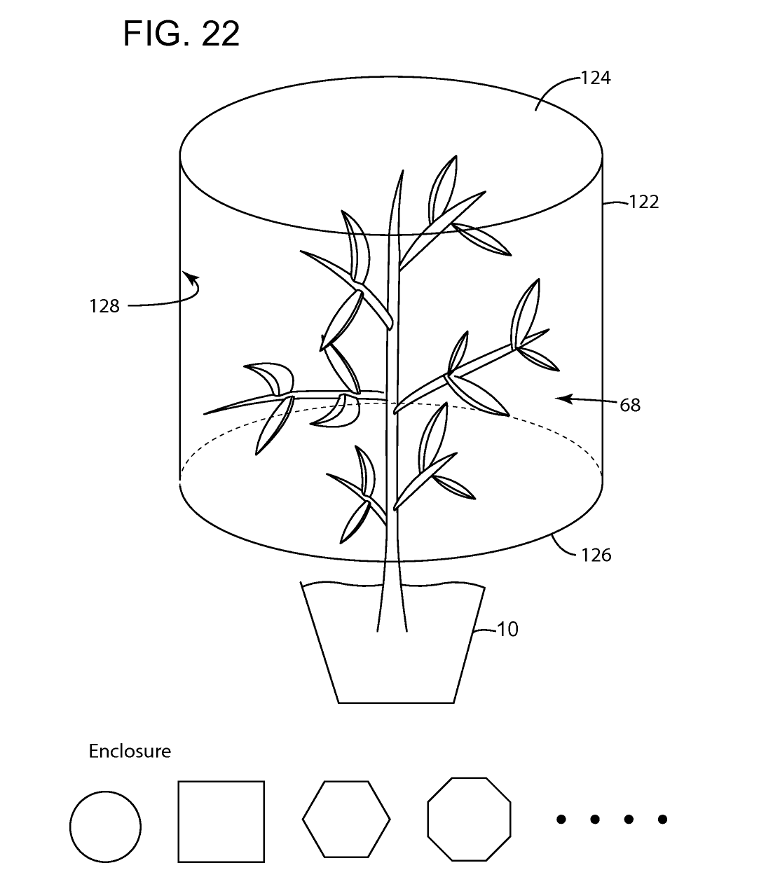

To overcome such deficiencies, FIG. 22 shows a system with a reflective enclosure 122, with an optional top 124, a bottom 126 and an optional reflective coating 128 on the enclosure 122. All of the light generated by the LEDs (not shown) will be confined to the inside of the enclosure 122, increasing the efficiency of the system. The enclosure can be round, square, hexagonal, octagonal, or any other shape.

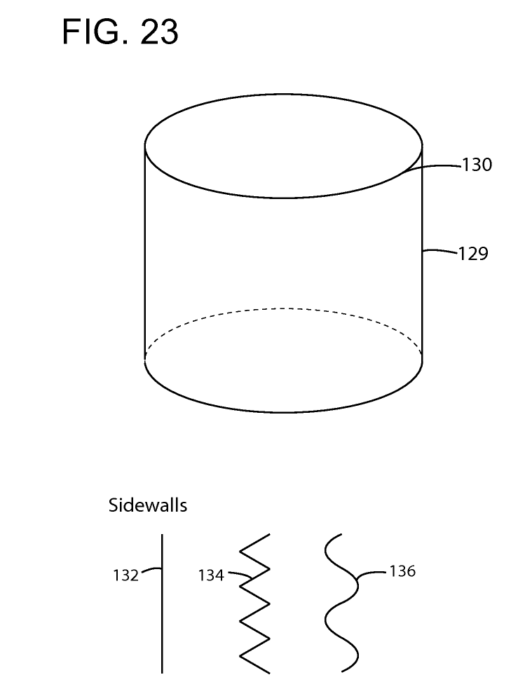

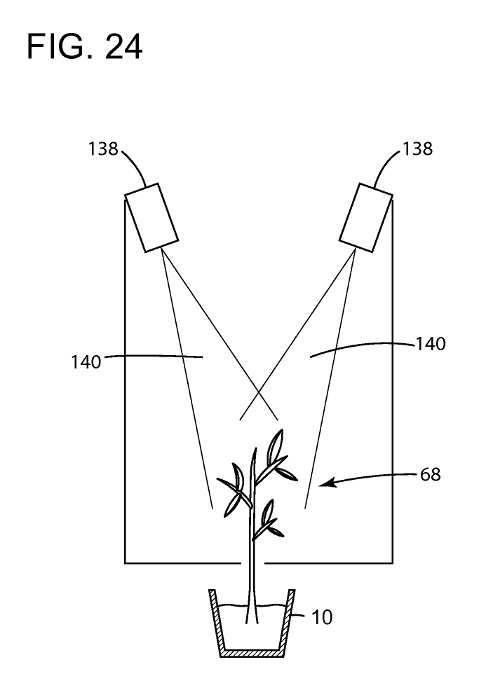

FIG. 23 shows other embodiments of the reflective sidewall 129 of the enclosure 130 in which the side wall can be straight 132, zigzag 134, curved 136, or any other shape to provide more structure to the enclosure. The sidewall shape may provide certain optical function to be described later.

FIG. 24 shows addition of spot lights 138 above and to the sides of the center of the plant 68. The spotlights 138 are preferably used during the early growth stage of the plant in which there are only a few small leaves. Light rays 140 from the spotlights 138 are thus focused on the initial leaves of the plant 68. In this embodiment, the LEDs (not shown) are preferably off during the early growth stage since their light would largely be unused, lowering the efficiency.

FIG. 25 shows another embodiment with zigzag side walls 134 having reflective surfaces. The sections alternate between horizontal and angled as shown. The light source can be placed at the corners as shown such that the light rays 142 will be directing downward towards the plant 68. Having light directing upward may cause ill effects to the plant and will not be efficient in photosynthesis.

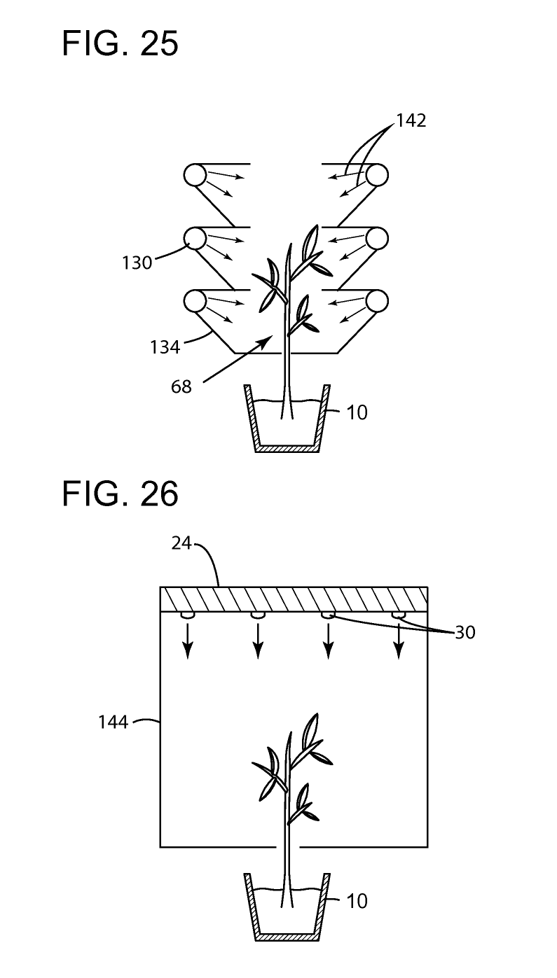

Alternately, as shown in FIG. 26, the enclosure 144 is square in cross-section. Each of the LED light sources 30 includes a linear heat sink with circuit board populated with one or more LEDs 30 which extend preferably from the top cover 24 of the enclosure 144. Depending on the type of plants, various colored LEDs can be used including white, red, green, blue, and other custom colors. One or more LEDs and one or more colors can be used at the same time. FIG. 26 shows an optional top where extra light from LEDs can be added when desired.

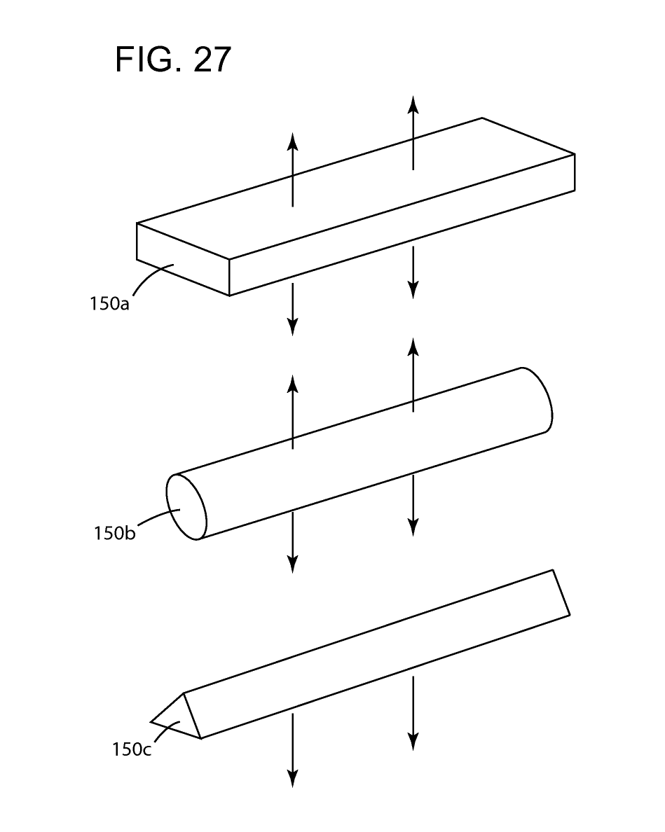

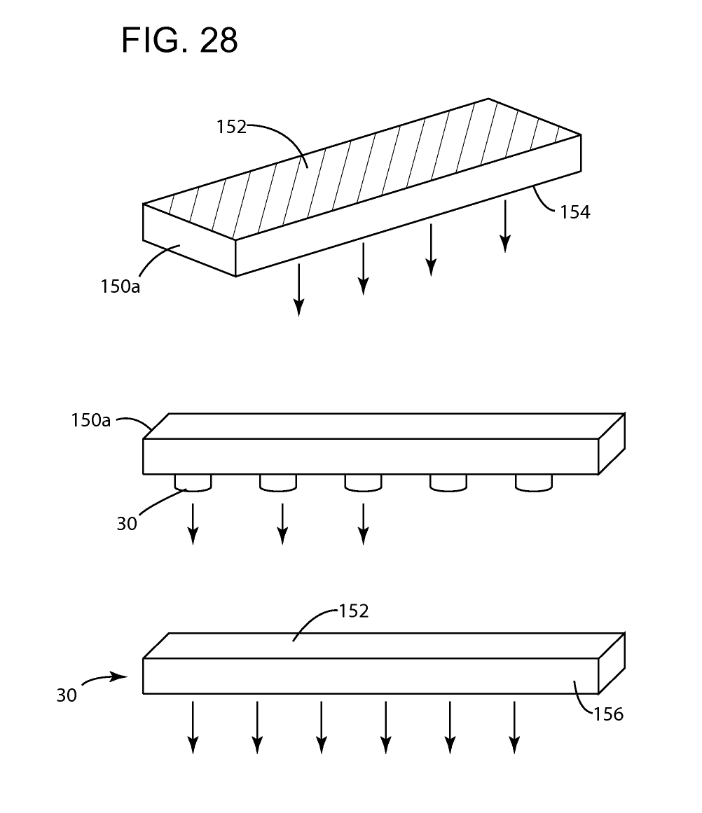

FIG. 27 shows examples of three types of light wands, rectangular in cross-section 150a, round in cross-section 150b, and triangular in cross-section 150c, which can be added inside any of the reflective enclosures, e.g., 20, when more light is desired. This is especially useful when the plant grows with dense leaves where the light from the top or from the side cannot reach these leaves. This will decrease the efficiency and growth rate of the plant. One or more of these light wands can be inserted through openings on the side of the enclosure and can be inserted between the leaves illuminating the leaves that would otherwise be in the dark. The light wand can have a cross-section of being square, rectangular, round, triangular, or other convenience shapes. The surfaces can be all bright, partially bright, or partially dark. For example, for the rectangular cross-section 150a as show, the top surface 152 can be dark so that it does not shine on the bottom of the leaves and the bottom surface 154 is bright so that it illuminates the top of the leaves promoting photosynthesis as shown in FIG. 28. To provide the light, LEDs can be mounted on one side of the light wand such that there will be no light at the top and light output is from the bottom only. Optionally, the top 152 can be painted black or covered with opaque covers.

In another embodiment, the light wand 156 can be end-lit in which the LEDs 30 are placed at the end of the light wand, which could be outside the enclosure for better heat sinking. The light wand will be made with diffusive materials or structured scattering surfaces similar to the system used in back lights for LCD panels. The top side can be made reflective so that all the light will be directed toward the bottom.

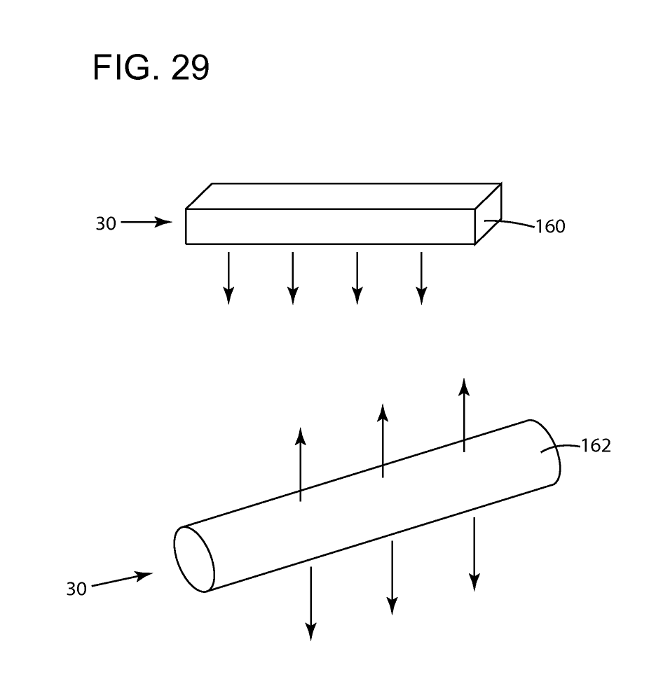

In another embodiment as shown in FIG. 29, the LEDs 30 can be placed along the length of the light wand 160 for edge lighting the diffusive material of which the wand 160 is made. The end-lit system can also be applied to a round light wand 162 with diffusive materials or surfaces as shown. The LEDs 30 input light to one end of the diffusive material wand 160 and 162. Preferably the opposite end has a reflective material. In the case of wand 160, preferably the top, the sides, and the end opposite to end containing the LEDs include a reflective material so that all of the diffused light comes out through the bottom surface. In the example of wand 162, the diffusive material of the light wand is uncovered except for the end opposite to the LEDs.

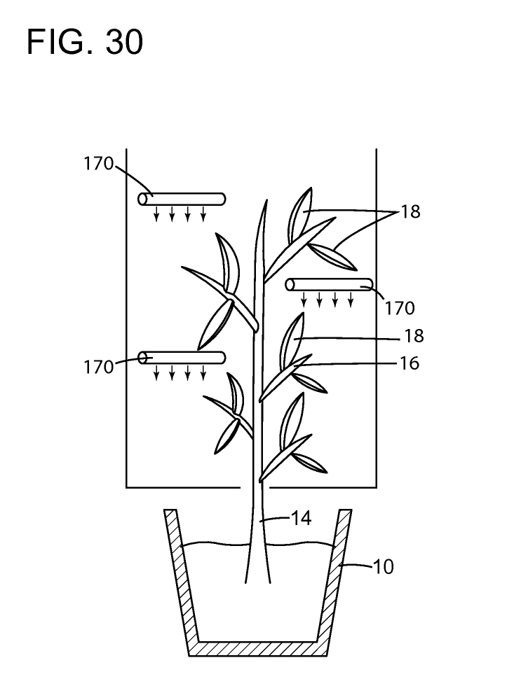

FIG. 30 shows the schematic diagram of a system in which one or more light wands 170 of the types described above are inserted through the enclosure wall for illuminating the top of the leaves.

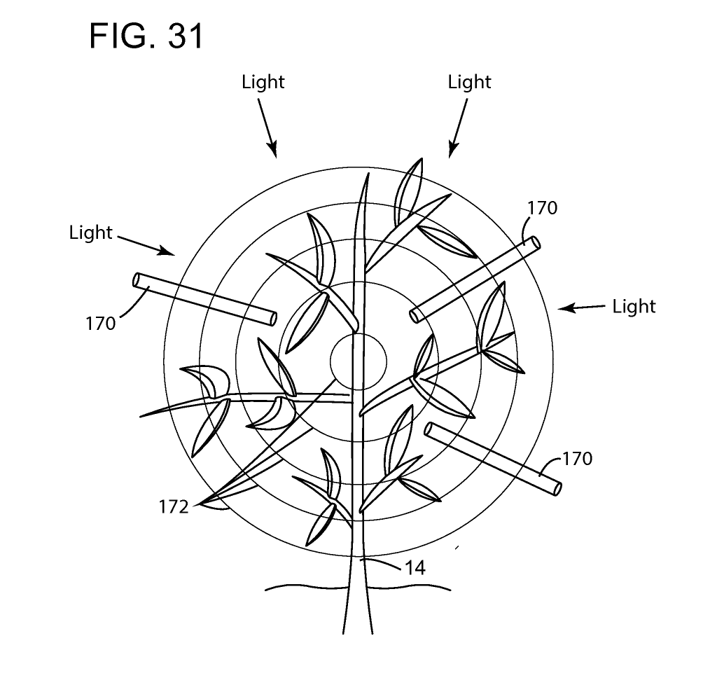

Referring to FIG. 31, light wands 170 can be used to illuminate the inside of a leafy vegetable such as lettuce 172. Normally, for these kinds of vegetables, the growth of the leaves is from the inside out such that as the vegetable grows, the sunlight will be absorbed mainly by the outer leaves in which photosynthesis occurs. As a result, the natural reaction of the vegetable is such that the outer leaves are greener than the inner leaves. As we all know, the inside leaves of a lettuce are usually whitish and are not as green as the outer leaves. Using light wands as shown in FIG. 31, the inner leaves are also illuminated providing photosynthesis, and it is natural that the inner leaves will also be green, providing more green nutrition for the same vegetable.

1. A system for growing a plant having a stem, branches, and leaves, comprising:
an inwardly reflective enclosure including at least a side portion for enclosing a plant on all four sides and a bottom portion, the bottom portion having a through hole for receiving a stem of a plant;
a plurality of LEDs acting as a light source for emitting light within said enclosure and illuminating predetermined portions of a plant whose branches and leaves are disposed within the enclosure; and
wherein a top portion of said enclosure either includes a top cover having air vents or is open to allow air to flow air into and out of the enclosure.

2. The system of claim 1, wherein said bottom portion additionally contains a plurality of air vents for allowing air to flow into and out of the enclosure.

3. The system of claim 1, further comprising a top cover containing at least some of said LEDs.

4. The system of claim 3, wherein said top cover includes air vents to allow air to flow into and out of the enclosure.

5. The system of claim 3, wherein said top cover is mounted within sidewalls of said enclosure for movement up and down.

6. The system of claim 3, further comprising a control unit which communicates with the LEDs to control the lighting of the LEDs.

7. The system of claim 6, further comprising a heater element which is controlled by the control unit.

8. The system of claim 6, further comprising a light intensity sensor which communicates with the control unit.

9. The system of claim 6, further comprising a light intensity sensor which communicates with the control unit for controlling the light intensity.

10. The system of claim 3, wherein the inwardly reflective enclosure comprises inner and outer walls with a reflective film sandwiched in between.

11. The system of claim 3, wherein said side portion has a plurality of LEDs.

12. The system of claim 3, further comprising a recycling collar associated with at least one selected LED, the recycling collar having an inwardly curved reflective portion facing the selected LED and a central opening for allowing light rays having less than a predetermined angle to pass through towards the plant and reflecting light rays having more than such predetermined angle back towards said LED for recycling.

13. The system of claim 12, further comprising a lens positioned between the central opening and the plant.

14. The system of claim 13, wherein the lens is a collimating lens.

15. The system of claim 3, wherein the top cover is formed of a plurality of panels movable between a closed position, where the panels interact with one another to at least substantially present light from leaving the enclosure, and an open position, where light can substantially freely flow into and out of the enclosure.

16. The system of claim 15, wherein each panel is elongated along an axis which extends through the panel and rotates about said axis between the open and closed positions.

17. The system of claim 3, further comprising a second inwardly reflective enclosure sharing a common wall with the inwardly reflective enclosure; wherein the common wall includes air passages; wherein the inwardly reflective enclosure and second inwardly reflective enclosure each has at least one LED; and wherein the control unit is programmed to operate the LEDs such that each enclosure operates alternately in light and dark phases to exchange oxygen and carbon dioxide with the other enclosure, with one chamber operated in a dark phase while the other is in a light phase.

18. The system of claim 3, wherein the enclosure is selectively shaped as a cylinder, cone, dual parabolic mirror, or truncated dual parabolic mirror to achieve a desired light reflection pattern within the enclosure.

19. The system of claim 3, wherein the side portion is formed of a zig-zag pattern or a series of curves.

20. The system of claim 3, further comprising at least one spot light which can be used during early plant growth in place of the LEDs.

21. The system of claim 20, comprising a control unit controls the operation of the spot light and LEDs.

22. The system of claim 3, comprising a plurality of LEDs located in the side portion for directing light laterally and down toward the plant leaves.

23. The system of claim 1, further comprising at least one light wand having a light source and outputting light in a predetermined direction, and further comprising mounting hardware for mounting said light wand inside said enclosure at a selected location and orientation for providing additional light to a portion of the leaf or leaves of the plant.

24. The system of claim 3, further comprising a second sharing a common wall with the inwardly reflective enclosure; wherein the common wall includes air passages; wherein the second inwardly reflective enclosure acts as a sacrificial enclosure for containing decaying organic matter to generate carbon dioxide for the reflective enclosure.

25. A method for growing a plant having a stem and leaves comprising the steps of:
fitting a first inwardly reflective enclosure over the plant such that the stem protrudes from the enclosure and the leaves are inside the enclosure; and
providing at least one LED to shine light inside the enclosure at a selected portion of the plant.

26. The method of claim 25, further comprising the steps of:
providing a second inwardly reflective enclosure and at least one LED to shine light inside the second enclosure;
placing a second plant inside of the second enclosure such that the leaves are inside the second enclosure and the stem projects out of the second enclosure;
operating the LEDs to so that each enclosure goes through alternating light and dark phases, wherein the second enclosure is dark when the first enclosure is light and the second enclosure is light when the first enclosure is dark; and
exchanging air between the first and second enclosures such that excess oxygen produced when an enclosure is lit, and excess carbon dioxide produced when an enclosure is dark, is provided to the other enclosure to promote growth.

27. The method of claim 25, further comprising the steps of:
providing a second inwardly reflective enclosure;
placing sacrificial plant matter inside the second enclosure to provide carbon dioxide; and
exchanging air between the first and second enclosures such that carbon dioxide produced inside the second enclosure is provided to the first enclosure when lit.

28. The method of claim 25, further comprising the steps of:
when a plant is young, providing at least one spotlight for shining light within said first enclosure on the leaves of the plant instead of using the LEDs.

29. The method of claim 25, further comprising the steps of:
when a plant is young, securing at least one reflecting collar having a center opening within said first enclosure, the reflecting collar having an inwardly curved surface facing an LED for concentrating the light emitted by the LED directed toward the young plant, and removing the collar when a plant reaches a predetermined maturity.

30. The method of claim 25, comprising the further step of providing an LED light wand which emits light in at least one predetermined direction, and inserting said light wand among the leaves of the plant for illuminating an interior leaf surface of the plant.
